(19) United States
(12) Patent Application Publication
(10) Pub. No.: US 2019/0147456 A1
(43) Pub. Date: May 16, 2019

(54) Computer-Implemented Monitoring of Compliance with Legislation in Case of Legislative Changes

(71) Applicant: Enhesa sa, Elsene (BE)

(72) Inventor: Peter Hermans, Merelbeke (BE)

(21) Appl. No.: 16/191,854

(22) Filed: Nov. 15, 2018

(30) Foreign Application Priority Data
Nov. 16, 2017 (BE) 2017/5843

(51) Int. Cl. G06Q 30/00

(52) U.S. Cl. CPC G06Q 30/018

(57) ABSTRACT

The present invention relates to a computer-implemented method, a computer system and a computer program product for monitoring compliance with legislation in case of legislative changes. A legislative event log, a compliance event log, and an activity overview comprising a plurality of activities are provided. An activity comprises an activity description and at least one legislative identifier. A legislative event concerning a change in a provision is added to the legislative event log. The legislative event comprises at least one legislative identifier regarding the provision, an effective time of the change, and, if the change is an addition or amendment, a provision description. A compliance event is added to the compliance event log comprising the effective time of the legislative event and compliance data. The compliance data for an activity of the activity overview, where said activity has at least one legislative identifier in common with the added legislative event, comprises an amendment of the compliance assessment according to the amended provision.

### TECHNICAL FIELD

The invention relates to a computer-implemented method, a computer system, and a tangible non-transitory computer-readable data carrier comprising a computer program product for monitoring compliance with legislation in case of legislative changes.

### PRIOR ART

US 2002/0 120 648 describes a system for accessing documents in a remote database, which change from version to version. The system allows users to specify a list of interesting documents. On the basis of the list, the system manages an archive, which contains a copy of a version of each document in the list, as well as material on the basis of which the other versions can be reconstructed. The system periodically compares the archive with current versions of the documents in the database, and adjusts the archive to safeguard the possibility of constructing the current versions.

US 2003/0 135 520 describes a dynamic legal database that provides historical and current versions of legislation. Time information can be used to manage access to and display of legislative items based on time as search parameter.

US 2005/0 125 443 describes the automated interpretation of codes, such as legal provisions, and their representation as rules that form logical expressions. Conversion of the codes can be carried out manually, or partially or fully automated. The interests of a party affected by the codes are represented by evaluation functions. The evaluation functions form logical conditions that relate to a utility of the party. For events related to the codes, such as possible or actual violations, the logical expressions are evaluated using the evaluation functions.

US 2009/0 177 664 describes a system and a method for generating and maintaining a database for compliance rules. Compliance requirements for a jurisdiction are determined by legislation and competent authorities. The compliance requirements are converted into computer-implemented compliance rules that are stored in the database. A computer system uses these compliance rules by extracting data from a data system of an institute, creating and archiving a data file on the basis of the data, comparing the data file and the computer-implemented compliance rules, and preparing a report based on of this comparison.

US 2012/0 072 450 describes systems, methods and software for looking up statutory information. An illustrative system allows a user to access statutory information by citation, by table of contents, by index and/or by popular name; presents specific statutory information in combination with visual indicators, such as red or yellow flags; and provides the requested statutory information in the form of links to related information, such as tables of contents, other versions of a statute, case law, academic materials, legislative history, cross-referenced statutes, and material related to administrative law.

US 2015/0 169 677 describes a system for monitoring government rules and legislative developments. The system provides for looking up relevant laws and legislative developments based on keywords.

The systems and methods from the above documents do not provide for the monitoring of legislative changes for certain activities. The present invention aims to solve at least some of the problems or disadvantages mentioned above.

### SUMMARY OF THE INVENTION

In a first aspect, the present invention relates to a computer-implemented method for monitoring compliance with legislation in case of legislative changes, according to claim 1.

In a second aspect, the present invention relates to a computer system for monitoring compliance with legislation in case of legislative changes, according to claim 14.

In a third aspect, the present invention relates to a tangible non-transitory computer-readable data carrier comprising a computer program product for monitoring compliance with legislation, according to claim 15.

The present invention is advantageous because by means of the legislative event log and the compliance event log, both legislative changes and implications of legislative changes for certain activities are monitored.

### DETAILED DESCRIPTION

The present invention relates to a computer-implemented method, a computer system, and a tangible non-transitory computer-readable data carrier comprising a computer program product for monitoring compliance with legislation in case of legislative changes. The invention was summarized in the section provided for this purpose. In the following, the invention is described in detail, preferred embodiments are explained, and the invention is illustrated by way of examples.

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise” and “comprising” are inclusive or open terms that indicate the presence of what follows, and which do not exclude or prevent the presence of other components, characteristics, elements, members, steps, etc.

In this document, “input device” refers to a device capable of providing input to a digital user device. This input is not limited to a particular modality and can comprise mechanical movement, sound, images, etc. The input can be discrete and/or continuous. The input is also not limited by the number of degrees of freedom. The input can concern both direct and indirect input. When providing input with respect to a position or the change thereof, such as an indicator on a screen, the input can be both absolute and relative. A non-exhaustive list of examples of input devices comprises a keyboard, a computer mouse, a touchpad, a touchscreen, a camera, a scanner, a joystick, a microphone, a light pen, a trackball, a projected keyboard and a game controller. In this document, “at least one input device” preferably comprises a keyboard and a computer mouse. A list of examples of keyboards comprises a keyboard with push buttons, a projected keyboard, and a keyboard displayed on a touchscreen. A list of examples of computer mice comprises an optical computer mouse, a computer mouse with roller ball, a touchpad, and a touchscreen.

In this document, “output device” refers to a device capable of providing output from a digital user device. This output is not limited to a particular modality and can comprise mechanical movement, sound, images, etc. A non-exhaustive list of examples of output devices comprises a computer screen, a printer, a plotter, and a loudspeaker.

In this document, “change” refers to an umbrella term comprising adding, amending and removing. “Change” can therefore be an addition, an amendment and/or a removal.

In a first aspect, the present invention relates to a computer-implemented method for monitoring compliance with legislation in case of legislative changes. In a second aspect, the present invention relates to a computer system for monitoring compliance with legislation in case of legislative changes. In a third aspect, the present invention relates to a tangible non-transitory computer-readable data carrier comprising a computer program product for monitoring compliance with legislation in case of legislative changes. A person having ordinary skill in the art will appreciate that the computer system according to the second aspect is configured to perform the steps of the computer-implemented method according to the first aspect. A person having ordinary skill in the art will also appreciate that the computer program product according to the third aspect of the present invention is suitable for execution on a computer system according to the second aspect and comprises instructions for performing the steps of the computer-implemented method according to the first aspect. In what follows, therefore, no distinction is made between these three aspects. The following description and examples can therefore relate to each of these three aspects. The computer system comprises at least one central processing unit and a tangible non-transitory computer-readable storage system. The computer system may comprise at least one input device. The computer system may comprise a communication module for internet communication.

A digital activity overview, a digital legislative event log, and a digital compliance event log are provided, for example, on the storage system of the computer system. Preferably, the legislative event log is an append-only database. Preferably, the compliance event log is an append-only database. The activity overview comprises a plurality of activities. An activity comprises an activity description and at least one legislative identifier. A legislative identifier may comprise at least one of a legislative reference number and a keyword. A legislative event concerning a change in a provision is added to the legislative event log. The legislative event comprises at least one legislative identifier regarding the provision, an effective time of the change, and if the change is an addition or amendment, a provision description. If the change is a removal, the legislative event may or may not comprise a provision description. A compliance event is added to the compliance event log comprising the effective time of the legislative event and compliance data. Preferably, the adding of the compliance event to the compliance event log is automatically triggered and executed based on the addition of the legislative event to the legislative event log. The compliance data for an activity of the activity overview, where said activity has at least one legislative identifier in common with the added legislative event, comprises an amendment of the compliance assessment according to the amended provision. A compliance event may involve one activity, i.e., a separate compliance event is added to the compliance event log for each relevant activity. Alternatively, a compliance event may involve multiple activities, i.e., one compliance event is added to the compliance event log for each legislative event, for all corresponding modified compliance assessments of relevant activities. A “relevant” activity here comprises at least one legislative identifier common to the added legislative event.

This is advantageous because the present invention provides for both keeping track of legislative changes via the legislative event log, and for providing corresponding compliance assessments via the compliance event log. A compliance event is created on the basis of an added corresponding legislative event. Not only does the present invention allow compliance corresponding with a legislative change to be monitored, but the present invention also provides an audit trail in the event logs to monitor changes in legislation and/or compliance.

In a preferred embodiment, a legislative microservice is provided. The legislative microservice is configured/comprises instructions for calling up via the internet from an external server, e.g. a government server, digital legislative change information concerning a change in a provision and an effective time. Preferably, said legislative change information comprises an HTML page or a PDF document. The legislative microservice is configured/comprises instructions for determining at least one legislative identifier based on the legislative change information. Alternatively, the at least one legislative identifier can be provided in advance and said legislative change information is called up from said external server via the at least one legislative identifier provided in advance. The legislative microservice then adds a legislative event to the legislative event log concerning the change in the provision. The legislative event thus comprises the at least one legislative identifier, the effective time, and if the change is an addition or amendment, a provision description. If the change is a removal, the legislative event may or may not comprise a provision description. Preferably, the legislative microservice is configured/comprises instructions for calling up via the internet at a plurality of predetermined times, more preferably at regular intervals, legislative change information from the external server. Alternatively or additionally, digital legislative change information regarding a change of a provision and an effective time can be called up via the internet from the external server via at least one input device of the computer system. Legislative changes can be closely monitored in this way. Preferably, a legislative event is added to the legislative event log before the effective time.

In a preferred embodiment, a compliance microservice is provided. The compliance microservice is configured/comprises instructions for monitoring additions of legislative events to the legislative event log; checking, based on the at least one legislative identifier of an added legislative event, whether an amendment of a compliance assessment must be created; preparing an amendment to a compliance assessment concerning an added legislative event and an activity; and adding to the compliance event log of a compliance event comprising the effective time of the added legislative event and compliance data comprising the compliance assessment. Changes in compliance that occur as a result of legislative changes are closely monitored in this way. Preferably, a compliance event is added to the compliance event log before the effective time.

In a preferred embodiment, a digital activity event log is provided, for instance on the storage system of the computer system. Preferably, the activity event log is an append-only database. An activity event concerning a change of an activity is added to the activity event log. The activity event comprises an effective time of the change of the activity and, in case of addition or amendment of the activity, an activity description. At least partially on the basis of the activity event log, a digital activity overview can be created comprising a validity time and a plurality of activities valid at the validity time. Each activity also includes an activity description and at least one legislative identifier. A second digital activity overview can be created comprising a second validity time based on a first digital activity overview comprising a first validity time, the first validity time before the second validity time, and the activity events of the activity event log comprising an effective time within a time window determined by the first and second validity times. Preferably, an activity microservice is provided for adding activity events to the activity event log.

In a preferred embodiment, at least partially based on the legislative event log, a digital legislative overview can be created comprising a validity time and a plurality of legislative items valid at the validity time. A legislative item comprises at least one legislative identifier and a provision description. A second digital legislative overview can be created comprising a second validity time based on a first digital legislative overview comprising a first validity time, the first validity time before the second validity time, and the legislative events of the legislative event log comprising an effective time within a time window determined by the first and second validity times.

In a preferred embodiment, at least partially based on the compliance event log and an activity overview, a digital compliance overview comprising a validity time and for each activity of the activity overview a compliance assessment as to whether the activity description satisfies corresponding provision descriptions, can be created.

In a preferred embodiment, a compliance timeline can be created based on the activity event log, legislative event log, and compliance event log. The compliance timeline is more specifically created based on the compliance assessments of one or more activities over time. The compliance timeline considers the effective times of activity, legislative and compliance events in the respective event logs. In this context, a person having ordinary skill in the art will appreciate that an effective time of a change of an activity, where the change is a removal, is to be interpreted as a stopping time of this activity.

In a preferred embodiment, an activity description of an activity of the activity overview and/or the activity event log comprises a parameter value. Further, the legislative event log comprises a legislative event concerning an addition or amendment of a provision, wherein the legislative event comprises a provision description comprising a logical expression comprising a parameter. To create a compliance assessment, the parameter of the logical expression is substituted by the parameter value, and the thus obtained expression is evaluated.

In a preferred embodiment, an activity overview comprises contact information and upon the addition of a compliance event to the compliance event log an electronic message is sent based on the compliance event and the contact information. Preferably, the contact information comprises an email address and the electronic message is an email.

Below, the invention is described by reference to a non-limiting example illustrating the invention, and that is not intended to be interpreted to limit the scope of the invention.

### EXAMPLE

Three linked microservices are carried out on a server system.

An activity microservice is linked to an activity event log. A customer can log in to the server system and provide activity information. The activity information concerns a change (addition, amendment or removal) of an activity. For example, the customer may specify that the company will thenceforth process substance X. After automated querying on the basis of a decision tree, which the customer answers via their computer, the activity microservice obtains the addition of an activity for the customer, namely the processing of substance X comprising hazardous substance Y in a concentration Z (activity description) from date A (starting date). On date B, later than date A, an activity overview for this customer is created by the activity microservice. The activity overview comprises date B as well as the activity of the processing of substance X comprising hazardous substance Y in a concentration Z1 (activity description) with starting date A.

A legislative microservice is linked to a legislative event log. At regular intervals, e.g. monthly, weekly or daily, the legislative microservice calls up legislative changes via the internet from a government server. An overview HTML page displays a list of legislative reference numbers and corresponding effective dates of legislative changes. The legislative microservice checks whether additions to the overview HTML page have been made concerning a change (addition, amendment or removal) of a legislative item. The microservice then requests the corresponding provision descriptions from the government server on the basis of the legislative reference numbers. The legislative microservice creates a legislative event, comprising the effective date of a change of a provision, the corresponding provision description if it concerns an addition or amendment, as well as the legislative reference number and keywords. The legislative microservice is linked to a keyword list. In the event of a legislative change, the legislative microservice checks in the provision description which keywords also appear in the corresponding provision description, and adds them to the legislative event. Each of the legislative reference numbers and the thus added keywords is a legislative identifier. The legislation concerning the processing of substance X become stricter on date C, later than date A and later than date B. For example, the new provision description prescribes that processing of substance X comprising hazardous substance Y is only allowed for concentrations of the hazardous substance Y lower than Z2, where this was previously Z3 (Z3>Z1>Z2). Well before date C, this is published on the overview HTML page available via the government server. The legislative microservice detects the legislative change, and adds a legislative event concerning the change to the legislative event log, where the legislative event comprises a logical expression comprising the limit value Z2 as well as the effective date C.

A compliance microservice is linked to a compliance event log. The compliance microservice monitors the legislative event log and is further linked to the activity overview created on date B comprising said activity with effective date A. Upon the addition of said legislative event, the compliance microservice determines, on the basis of the legislative identifiers of the legislative event, that the compliance assessment concerning the activity concerning substance X has to be revised. A legislative identifier may comprise e.g. substance “X”. Before date C it complies with the legislation, as of date C no longer. The compliance microservice determines the change of compliance based on the substitution of the concentration Z1 in the logical expression of the provision description of the legislative event; and the evaluation of the thus obtained expression. The logical expression with limit value Z3 provides in this case that the customer complies with the provision description before date C. The logical expression with limit value Z2 provides in this case that the customer no longer complies with the legislation as of date C. The compliance microservice then adds a compliance event concerning the activity to the compliance event log, namely that said activity no longer complies with the legislation, with effective date C. An automated electronic message, preferably an email, is sent to the customer regarding this non-compliance with effect from date C. The message comprises the provision description of the legislative change.

1. Computer-implemented method for monitoring compliance with legislation in case of legislative changes, comprising the steps of:
providing a digital activity overview comprising a plurality of activities, an activity comprising an activity description and at least one legislative identifier;
providing a digital legislative event log;
providing a digital compliance event log;
adding to the legislative event log of a legislative event concerning a change in a provision, a change being an addition, amendment or removal, the legislative event comprising at least one legislative identifier concerning the provision, an effective time of the change, and, if the change is an addition or amendment, a provision description; and
adding to the compliance event log of a compliance event comprising the effective time of the legislative event and compliance data, said compliance data comprising, for an activity of the activity overview with at least one legislative identifier common to the added legislative event, a change of a compliance assessment according to the change in the provision.

2. Computer-implemented method according to claim 1, comprising the steps of:
calling up via the internet from an external server of digital legislative change information concerning a change of a provision and an effective time;
determining at least one legislative identifier on the basis of the legislative change information; and
adding to the legislative event log of a legislative event concerning the change in the provision, the legislative event comprising the at least one legislative identifier determined, the effective time, and if the change is an addition or amendment, a provision description.

3. Computer-implemented method according to claim 2, wherein at a plurality of predetermined times, digital legislative change information is called up via the internet from the external server.

4. Computer-implemented method according to claim 2, wherein the legislative change information comprises an HTML page or a PDF document.

5. Computer-implemented method according to claim 1, wherein the legislative event log is an append-only database, and wherein the compliance event log is an append-only database.

6. Computer-implemented method according to claim 1, comprising the steps of:
providing a digital activity event log;
adding to the activity event log of an activity event concerning a change of an activity, the activity event comprising an effective time of the change and, upon addition or amendment of the activity, an activity description; and
creating, at least partly on the basis of the activity event log, of a digital activity overview comprising a validity time and a plurality of activities valid at the validity time, each activity comprising an activity description and at least one legislative identifier.

7. Computer-implemented method according to claim 6, wherein the activity event log is an append-only database.

8. Computer-implemented method according to claim 6, comprising the step of creating, on the basis of the activity event log, legislative event log, and compliance event log, of a compliance timeline based on the evolution of the compliance assessments of one or more activities over time.

9. Computer-implemented method according to claim 1, comprising the step of creating at least partially on the basis of the legislative event log of a digital legislative overview, the legislative overview comprising a validity time and a plurality of legislative items valid at the validity time, each legislative item comprising at least one legislative identifier and a provision description.

10. Computer-implemented method according to claim 1, comprising the step of creating, at least partially on the basis of the compliance event log, a digital compliance overview, the compliance overview comprising a validity time and for each activity of the activity overview a compliance assessment as to whether the activity description complies with corresponding provision descriptions.

11. Computer-implemented method according to claim 1, wherein a legislative identifier comprises at least one of a legislative reference number and a keyword.

12. Computer-implemented method according to claim 1, wherein an activity description of an activity of the activity overview comprises a parameter value, in which the legislative event log further comprises a legislative event concerning an addition or amendment of a provision, the legislative event comprising a provision description comprising a logical expression comprising a parameter, and wherein the method comprises the steps of substituting the parameter of the logical expression of the provision description of the legislative event by the parameter value of the activity description; and the evaluation of the thus obtained expression.

13. Computer-implemented method according to claim 12, wherein said logical expression comprises a limit value.

14. Computer system for monitoring compliance with legislation in case of legal changes, the computer system comprising at least one central processing unit and a tangible non-transitory computer-readable storage system comprising an activity overview, a legislative event log and a compliance event log, the activity overview comprising a plurality of activities, an activity comprising an activity description and at least one legislative identifier, wherein the computer system is configured for:
adding to the legislative event log of a legislative event concerning a change in a provision, a change being an addition, amendment or removal, the legislative event comprising at least one legislative identifier concerning the provision, an effective time of the change, and, if the change is an addition or amendment, a provision description; and
adding to the compliance event log of a compliance event comprising the effective time of the legislative event and compliance data, said compliance data comprising, for an activity of the activity overview with at least one legislative identifier common to the added legislative event, a change of a compliance assessment according to the change in the provision.

15. Tangible non-transitory computer-readable data carrier comprising a computer program product for monitoring compliance with legislation in case of legal changes, the computer program product suitable for execution on a computer system comprising at least one central processing unit and a tangible non-transitory computer-readable storage system, the storage system comprising an activity overview, a legislative event log and a compliance event log, the activity overview comprising a plurality of activities, an activity comprising an activity description and at least one legislative identifier, the computer program product comprising instructions for:
adding to the legislative event log of a legislative event concerning a change in a provision, a change being an addition, amendment or removal, the legislative event comprising at least one legislative identifier concerning the provision, an effective time of the change, and, if the change is an addition or amendment, a provision description; and
adding to the compliance event log of a compliance event comprising the effective time of the legislative event and compliance data, said compliance data comprising, for an activity of the activity overview with at least one legislative identifier common to the added legislative event, a change of a compliance assessment according to the change in the provision.
